(19) United States
(12) Patent Application Publication
(10) Pub. No.: US 2003/0212770 A1
(43) Pub. Date: Nov. 13, 2003

(54) System and method of controlling software components

(76) Inventors: Sreekrishna Kotnur, Bangalore (IN); Sasank Kotnur, Bangalore (IN)

Correspondence Address: Welsh & Katz, Ltd., 22nd Floor, 120 South Riverside Plaza, Chicago, IL, 60606, US

(21) Appl. No.: 10/144,242

(22) Filed: May 10, 2002

(51) Int. Cl. G06F 15/177; G06F 15/173

(52) U.S. Cl. 709/220; 709/223

(57) ABSTRACT

A system for controlling software components involves a server for starting and shutting down a component remotely from the server. Automated code generation for the startup and shutdown may be provided. The system can include a first computing environment and a second computing environment. In use, the software component of the second computing environment is responsive to the component server of the first computing environment by way of the component client of the second computing environment. The component server reads and stores information of the software component, generates shutdown codes for the software component, parses through the registry to determine the component client in the same computing environment as the software component, and configures the component client in the same computing environment as the software component to control the software component

### FIELD OF INVENTION

The present invention relates generally to the control of computers. In particular, in an object oriented programming environment, the invention relates to methods of dynamically and at runtime, starting or stopping software components.

### BACKGROUND OF THE INVENTION

Building better software in very less time is a goal of many software producers, big and small. In the last couple of decades significant advances have been made to achieve this goal. The advances have led to new and easier programming languages, better database systems and significant improvements in component or object oriented techniques. One such very significant improvement is the advent of component based development/programming technique.

Component based programming or development of computer software generally involves writing or developing small software components, which do specific work, and integrating the software components with additional software components. The integrated components then form a larger component or an application. Component based development has enabled a true implementation of one of the object oriented techniques, namely, “reusability.” Reusability reflects the ability to reuse previously-written software components to create new applications. Building software from these components means creating an application in whole or in part from existing components rather than starting anew each time.

The use of software component technology is greatly prevalent in distributed computing environment. Distributed computing environments may have a plurality of computing environments, which may be in electronic communication by way of a computer network. In a distributed computing environment different components, which are disbursed over a network of computers, perform different tasks. This makes it difficult to control components located remotely, i.e. not located on the same machine. In such a distributed computing environment, it is advisable and advantageous to have a mechanism by which one can control the state of components that are located remotely.

Some of presently available middleware servers can start and stop components that are contained within them by invoking certain Application Programming Interfaces (“APIs”). Since the components are considered as an integral part of the middleware server, the middleware server only needs to initialize component each component when a call is made for the component, and de-initialize the same when the reference is not present.

However, existing middleware servers do not control remotely located software components. The state of remote components is typically controlled by individually writing a computer code and programming the APIs provided by different vendors, or by programming the API's of the Operating Systems or the platform on which the component resides. Thus, remote control of software components involved, prior to the present invention, significant involvement in writing specialized, individual code for each component. While some programs have tried to address the issue of starting remote components within their remote systems from another remote system, there is no known mechanism or tool by which one can dynamically and at run time, control the state of a remote component without programming the APIs.

Remote start and shutdown of a remote software component is desirable because, at times, there are many possibilities for a component to behave erratically. A system that facilitates the remote shutting and starting of components would provide administrative convenience and would also be commercially desirable. Further, it would also be advantageous to have a uniform system by which one can control distributed components deployed on heterogeneous environments, and or developed in different languages.

Accordingly, there is a need for remote object startup and shutdown actions to be initiated on distributed components located in heterogeneous environments, and which are developed in different computer programming languages, without any human effort or programming of APIs.

### SUMMARY OF THE INVENTION

A system for controlling software components is provided. Typically, but not necessarily, the control of a software component involves a server starting and shutting down a component remotely from the server. Automated code generation for the startup and shutdown may be provided. The system includes a first computing environment and a second computing environment. The first and second computing environments may be different computers. The first and second computing systems may also employ different operating systems. The first computing environment is configured to include a component server, a client reference repository associated with the component server and a registry associated with the component server. The client reference repository may include a client reference corresponding to a component client. The registry may include component details corresponding to the software component and client details corresponding to the component client. The second computing environment is configured to include a component client, responsive to the component server, a component reference repository associated with the component client and at least one software component, responsive to the component client. In use, the software component of the second computing environment is responsive to the component server of the first computing environment by way of the component client of the second computing environment. Numerous software components and component clients may be controlled in this manner.

The component details stored in the registry may comprise the bind name and location of a software component. The component reference repository may include a component reference relating to a software component, a process ID relating to a software component, or both. The component reference repository may also include an invoking object relating to the software component.

In operation, the component server may read and store information of the software component, generate shutdown codes for the software component, parse through the registry to determine the component client in the same computing environment as the software component, and configure the component client in the same computing environment as the software component to control the software component. The component server may also generate a startup code to enable automated start up of the software components. The component server may also receive information relating to the software component from an application, store information in temporary storage objects, and retain the temporary storage objects on the component server until the software component is configured with the component client. The component server may then transfer the temporary storage objects to the component client and updates the relevant registries. The component server may also generate appropriate component shutdown and invoking codes and transfer the codes to an application and the component client, respectively.

The component server may also generate a startup code containing the startup parameters specific to the component which is stored in a startup object, generate the startup code to invoke the operating system to start the software component, generate the startup code to obtain the process ID of the software component at startup, and transfer the startup code to the component client. The component server may also receive the information corresponding to the software component, parse through the registry to identify the component client as being associated with the computing environment of the software component, and assign startup and shutdown tasks to the component client.

The component client may read the location of the software component from the component details of the software component received from the component server, start the software component by invoking a local Java Virtual Machine, obtain the process ID of the software component from an operating system, and store the process ID in the component reference repository. The component client may starts the software component by loading libraries associated with the software component or by executing at least one executable file associated with the software component.

The component client may shut down a component by reading the location of the software component from the component details received from the component server and extracting and killing the process ID. The component client may also shut down a component by invoking a shutdown code in the software component. In this example, the component client retrieves a remote reference of the software component from the component reference repository, executes an invoking code corresponding to the software component, triggers a shutdown code with the invoking code, and executes the shutdown code of the software component.

The system may also comprise a third computing environment configured to include a scheduler. The component server in such a variation is responsive to the schedule. The component server may run the scheduler at startup and update the registry with the status of the scheduler. The scheduler prepares a schedule key and store the schedule key with the registry, parses the registry and extracts the schedule key on establishing connection with the server, and determines the scheduled task to be run and notifies the component server regarding the same. The scheduler prepares a schedule key by processing the component details of the software components, preparing the schedule of startup and shutdown of the components, and storing the schedule in the schedule key.

Benefits which may be realized from the above described system include:

Automated code generation to enable control, such as startup and shutdown, of remote components;

Control of remote components developed in different languages and residing on heterogeneous environments;

A mechanism for configuring the components that need to be controlled through the system at time of deployment; and

A scheduling mechanism to process task schedule requests for startup and shutdown of components.

The system eliminates the need of a programmer to explicitly program the component, with a computer code or program specific to stopping or starting the component, or even for scheduling the starting and shutdown of components or the configuring of the components, wherein the component can be either remote or local to the application executing this invention.

### BRIEF DESCRIPTION OF THE DRAWINGS

The various objects and advantages of the present invention will become apparent to those of ordinary skill in the relevant art after reviewing the following detailed description and accompanying drawings, wherein:

FIG. 1 is a block diagram that illustrates an example of the present invention;

FIG. 2 is a diagram that illustrates an example of a sequence of configuration of components to be controlled by an example of the present invention;

FIG. 3 is a diagram that illustrates an example of a sequence of starting remote components developed in JAVA Programming Language;

FIG. 4 is a diagram that illustrates an example of a sequence of shutting remote components;

FIG. 5 is a diagram that illustrates an example of the mechanism of automatically scheduling the startup or shutdown of remote components;

FIG. 6 is a diagram that illustrates the startup process of the Scheduler.

### DETAILED DESCRIPTION OF THE PREFERRED EMBODIMENT

One example of the present invention is herein described in more detail with reference to the drawings. The present invention is not restricted to this example. The present invention is applicable to any application or system that seeks to control, such as start and or stop, the component at runtime.

The example of the present invention, illustrated and described herein uses the JAVA programming language and environment. The use of this present invention is not restricted to JAVA only, and the use of this invention to other programming languages would be straightforward to one skilled in the art of programming. Also, whereas examples of control of a software component are given in terms of starting and shutting down the software component, other forms of control are contemplated and are within the scope of the invention.

It should be further understood that the title of this section of this specification, namely, “Detailed Description Of The Invention”, relates to a requirement of the United States Patent Office, and does not imply, nor should be inferred to limit the subject matter disclosed herein. In the present disclosure, the words “a” or “an” are to be taken to include both the singular and the plural. Conversely, any reference to plural items shall, where appropriate, include the singular.

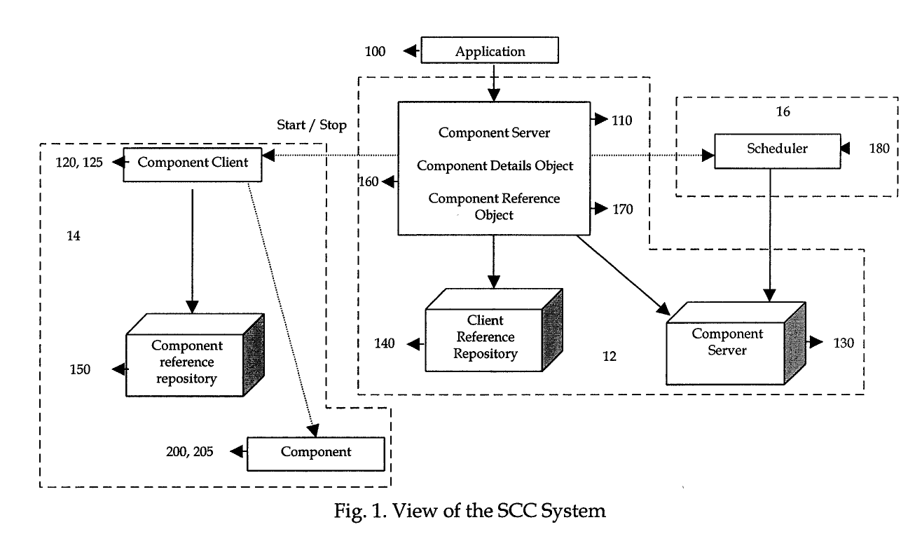

FIG. 1 illustrates one example of a software component control (SCC) system. Software components are often times also referred to as “objects.” In this example, a SCC system includes: an Application 100, a Component Server 110, one or more Component Clients 120, 125, a Component Server Registry 130, a Client Reference Repository 140, a Software Component 200, 205, a Component Reference Repository 150, a Component Details Object 160, a Component Reference Object 170, and a Scheduler 180.

The Component Server 110 acts as the controller and the Component Client 120, 125 as the actor. The role of the Component Server 110 is to identify the Component Client 120, 125 to contact for the particular task of starting or stopping the Software Component 200, 205 as the case may be. The Component Client 120 is responsive to the Component Server 110. The role of the Component Client 120, 125 is to perform the task assigned to it by the Component Server 110, for example, starting and stopping Software Components 200, 205 within its control.

Typically, the Component Server 110, the Client Reference Repository 140 and the Component Server Registry 130 are configured as part of a first computing environment 12 and the Component Client 120, and the Component Reference Repository 140 are configured as part of a second computing environment 14, where the second computing environment 14 further includes a Software Component 200 to be controlled. The advantages of the present invention are most advantageously used when these computing environments are different, thereby allowing the Component Server 110 to control a Software Component 200 of a different computing environment by way of the Component Client 120. However, the computing environments need not be physically separate and may reside on the same machine.

The Component Server Registry 130 stores the details of the Component Clients 120, 125. When a Component Client 120, 125 is installed, the Component Server 110 converts the Component Client 120 into a Client Details Key and stores the key in the Component Server Registry 130. Likewise the Component Server 110 stores the Component Client Reference in the Client Reference Repository 140. When a Component Client 120, 125 is uninstalled, the Component Server 110 removes the Client Details Key from the Component Server Registry 130 and the Component Client Reference from the Client Reference Repository 140. These Component Client details are needed to authenticate the Component Clients 120, 125 as a security measure. Only the authorized and authenticated Component Clients 120, 125 can communicate with the Component Server 110 and the Component Server 110 can assign tasks to only such Component Clients 120, 125.

Component Reference Repository 150 stores the Component Reference (as defined hereinafter) and the Process ID (as defined hereinafter) of the Components 200, 205.

The Component Details Object 160 is a temporary object that is stored on the Component Server 110. The Component Details Object 160 includes component details such as the bind name and location of the Software Component 200. The Component Clients 120, 125 require the Component Details to start the Components 200, 205. The Component Details may vary to suit the requirements of the application implementing the invention.

The Component Reference Object 170 is a temporary object that is stored on the Component Server 110 and contains the remote reference of the Software Component 200 (“Component Reference”). The Component Clients 120, 125 require the Component Reference to shutdown the Components 200, 205.

A third computing environment 16 can include a Scheduler 180. The Scheduler 180 stores details regarding the specific Components 200, 205, the type of task to be initiated and when such task has to be initiated. The Scheduler 180 invokes the Component Server 110, which calls upon the Software Component 200 that has to be started or shutdown. One example, the Scheduler 180 is co-located with the Component Server 110. In another example, the Scheduler 180 can exist on a remote machine from the Component Server 110.

There may be one Component Server 110 and a plurality of Component Clients 120, 125 in one example. In another example, there may be a plurality of Component Servers 110 and Component Clients 120, 125, wherein a Component Server 110 can communicate with a set of Component Clients 120, 125 and with other Servers. For example, a Component Server 110 may comprise a plurality of Component Servers 110, a Component Client 120 may comprise a plurality of Component Clients 120, and a Software Component 200 may comprise a plurality of Software Components. The Component Server 110 and the Component Clients 120, 125 may be distributed over several computers in a network. In another example, the Component Server 110 and the Component Clients 120, 125 may be located on the same computer. In another example, the Component Server 110 and the Component Clients 120, 125 may simultaneously exist on heterogeneous environments.

The Component Server 110 controls the startup and shutdown of the Components 200, 205. Every Software Component 200, 205 to be controlled is assigned to a particular Component Client 120, 125. The user selects the Software Component 200 to be controlled through SCC, by selecting the Software Component 200 through the Application 100.

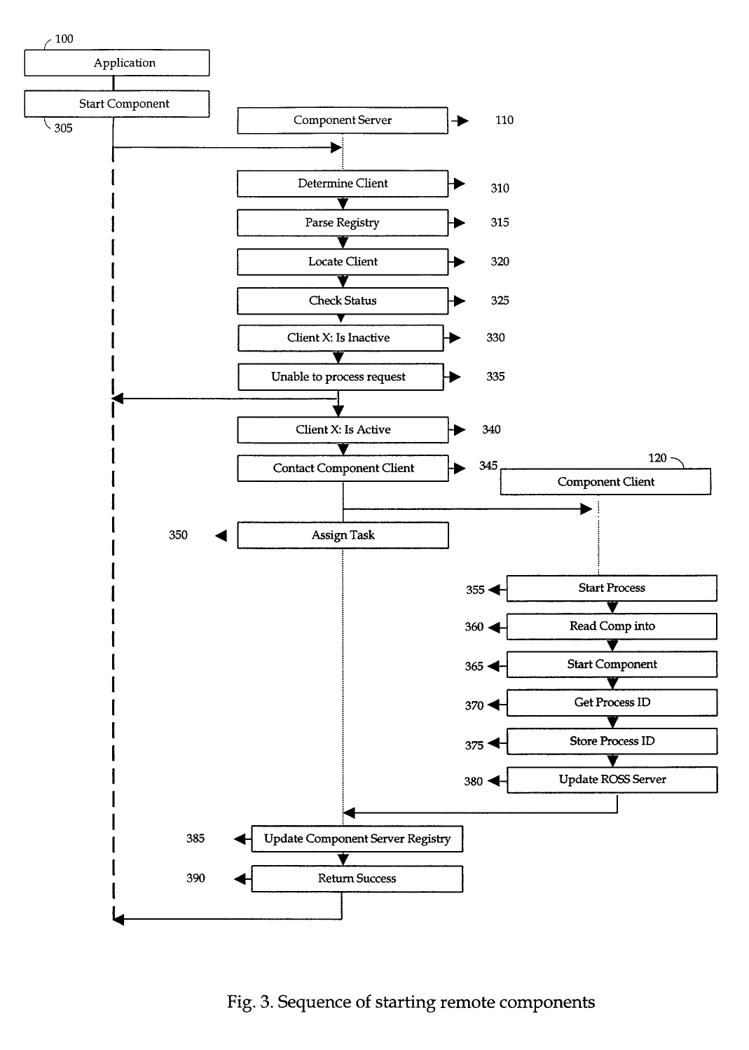

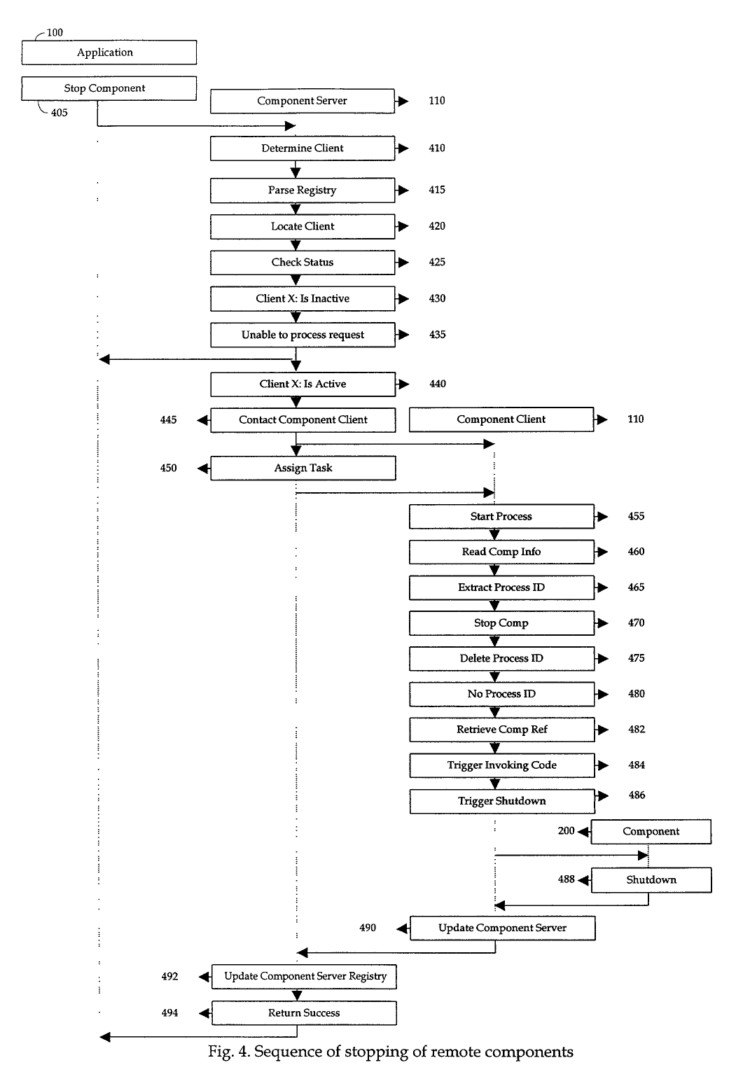

Upon receiving a request to start or shutdown the Software Component 200, the Component Server 110 parses through the Component Server Registry 130, which stores details of the Component Clients 120, 125, to identify the Component Client 120, 125 installed on the same machine as that of the Software Component 200 to be controlled. Thereafter, the Component Server 110 directs the respective Component Client 120 to execute the startup or shutdown process. The Component Client 120 implements the task assigned to it by the Component Server 110 to startup and shutdown a Software Component 200 within its control, as explained in FIG. 3 and FIG. 4.

A SCC system may provide methods by which the Application 100 communicating with the SCC system can invoke the code generation mechanism of the SCC system only when required, to generate the relevant Shutdown Codes (as defined hereinafter) for the Components 200, 205 being deployed.

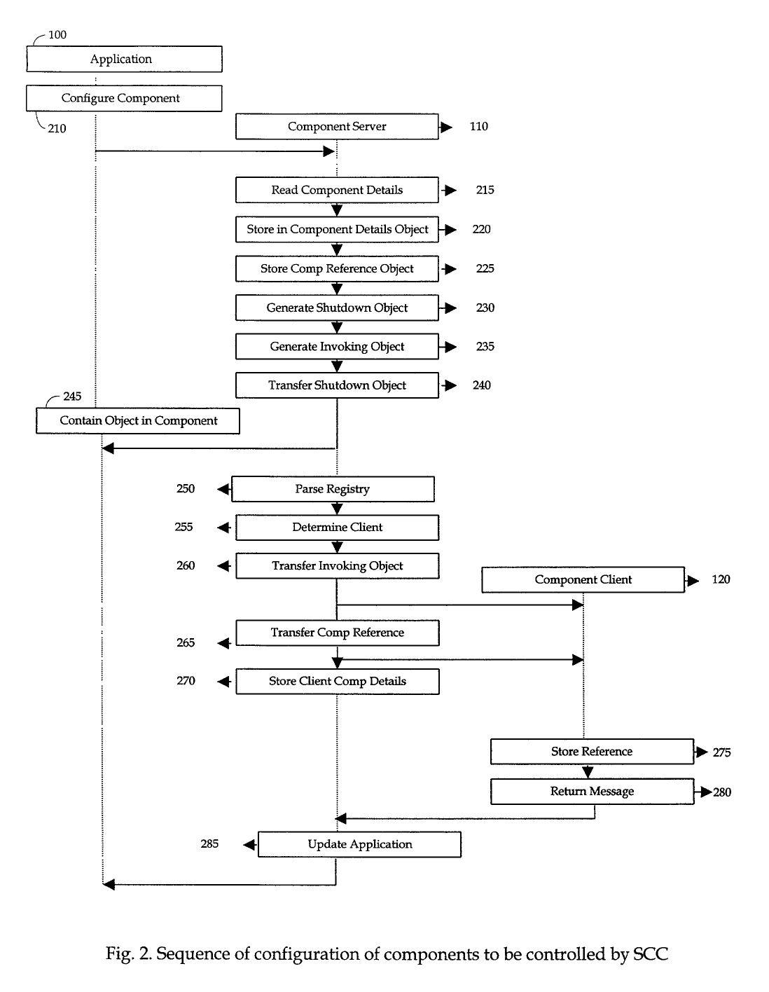

As illustrated in FIG. 2, once the user selects the Software Component 200 that needs to be configured by SCC, the Application 100 transfers the Component Information for the selected Software Component 200, such as the bind name, the location and the reference of the Software Component 200 to the Component Server 110, 210. The Component Server 110 then reads the Component Information 215 and stores the Component Details in the Component Details Object 160, 220. The Component Server 110 then separately stores the Component Reference in the Component Reference Object 170, 225.

The Component Server 110 generates pre-determined codes to shut down a Software Component 200 (“Shutdown Codes”). Generally the Shutdown Codes are invoked only if the Software Component 200 has not been started by SCC. If the Software Component 200 has been started by the SCC system, then the SCC system uses the Component's Process ID 405 to shutdown the Software Component 200, as explained in FIG. 4. The Shutdown Codes may consist of two parts: the Component Shutdown Code and the Invoking Code. The Shutdown Codes may consist of more codes or other different codes, which would be specific to the programming language in which the invention is written. The Component Shutdown Code is stored in an object created by the Component Server 110 (“Shutdown Object”) 230. The Component Shutdown Code may be the same for all the Components 200. The Component Server 110 stores the other part of the Shutdown Code, namely “Invoking Code” in another object (“Invoking Object”) 235. The Invoking Code is specific to each Software Component 200. The Component Server 110 transfers the Shutdown Object to the Application 100, 240. The Application 100 in turn, transfers and stores the Shutdown Object into the Software Component 200 during integration 245.

In another example, the Component Server 110 may directly write the Shutdown Object into the Software Component 200 without the need of the Application 100, provided the Component's source is available to the Server

After this, Component Server 110 parses the Component Server Registry 130, 250 to determine the Component Client 120 residing on the machine where the Software Component 200 is deployed 255. The Component Client 120 and the Software Component 200 may reside on the same machine. The Component Server 110 then transfers the Invoking Object 235, 260 and the Component Reference to the Component Client 120, 265. The computer languages used to develop the Component Server 110, the Component Client 120, the Component Server Registry 130, and reference repositories may be, but need not be, the same language. Indeed, one of the advantages of the present invention is that users are not limited to any particular language to achieve control of software components on a distributed computing environment.

In another example, using a programming language other than JAVA, the Component Server 110, also generates a startup code that is used to startup a Software Component 200 by the SCC system (“Startup Code”). The Startup Code contains a command for loading the library or executing the Component's 200 executable file, depending upon the parameters of the Software Component 200. The Startup Code is stored in an object created by the Component Server 110 and is also transferred to the Component Client 120.

In the illustrated example, the Component Server 110 then upgrades the Client Details and Component Details and proceeds to store them in the Component Server Registry 130, 270. The Component Client 120 stores the Component Reference in the Component Reference Repository 150, 275, and returns an acknowledgement to the Component Server 110 that the Component Reference has been on successfully stored (“Acknowledgement”) 280. The Component Server 110 informs and updates the Application 100 of the successful completion of the task 285.

If the Component Client 120 is unable to correctly process the transaction or fails to process the transaction, the Component Server 110 re-transmits the entire transaction as the Component Server 110 continues to hold the two temporary storage objects, namely the Component Details Object 160 and the Component Reference Object 170 until the entire transaction is completed. However, after the Component Server 110 receives the Acknowledgement 280, it destroys the Component Details Object 160 and the Component Reference Object 170. In the preferred embodiment, once the Software Component 200 is configured, it can be remotely started and stopped.

FIG. 3 illustrates an example of how the SCC system may start a remote Software Component 200, 205. When the user selects to start a Software Component 200 from the Application's 100 user interface, the Component Server 110 is triggered to start the Software Component 200, 305. The Component Server 110 collects the Component Details from the Application 100 and identifies the Component Client 120, 125 which handles the Software Component 200, 310, by parsing and reading the Component Server Registry 130, 315.

Once the Component Server 110 locates the Component Client 120 that is configured to control or process the Software Component 200, 320, it checks the status of the Component Client 120 to see if it is active or inactive 325. If the Component Client 120 is inactive 330, the Component Server 110 informs the Application 100 that it is unable to process the request at that time 335.

However, if the Component Client 120 is active 340, the Component Server 110 contacts the Component Client 120, 345 and assigns it the task of starting the Software Component 200 by passing the Component Details 350.

On being notified by the Component Server 110 the Component Client 120 commences the startup process 355 and reads the location/path from the Component Details 205 given to it 360. The Component Client 120 then starts and loads the Software Component 200 by invoking the local Java Virtual Machine 365. In an alternate embodiment not using the JAVA programming language, the Component Client 120 starts the Software Component 200 by invoking the Startup Code, which loads the library of the Software Component 200 or execute the executable file of the Software Component 200. Thereafter, the Component Client 120 obtains the Process ID of the Software Component 200 from the operating system 370. Every Process ID is pre-fixed with the name of the Software Component 200 like the bind name. The pre-fixed name is mapped with the Component Details, which enables the Component Client 120 to identify and extract the Process ID at the time of shutdown. The Component Client 120 stores the Process ID in a file in the Component Reference Repository 150, 375. The Component Client 120 notifies the Component Server 110 on successful completion of the task 380. The Component Server 110 then updates the Component Server Registry 130, 385. Finally, the Component Server 110 notifies the Application 100 or the user of the successful completion of the task 390.

If the Component Client 120 is unable to detect the Software Component 200, if for example, the path or location of the Software Component 200 has changed, the Component Client 120 may notify the Component Server 110 concerning the same.

FIG. 4 illustrates an example of how the SCC system may stop a remote Software Component 200. When the user selects to stop a Software Component 200 from the Application's 100 user interface, the Component Server 110 is triggered to stop the Software Component 200, 405. The Component Server 110 collects the Component Details from the Application 100 and identifies the Component Client 120, 125 which handles the Software Component 200, 410, by parsing and reading the Component Server Registry 130, 415. Once the Component Server 110 locates the Component Client 120 that is configured to control the Software Component 200, 420, it checks the status of the Component Client 120 to see if it is active 425. If the Component Client 120 is found to be inactive 430, the Component Server 110 informs the Application 100 that it is unable to process the request at that time 435. However, if the Component Client 120 is active 440, the Component Server 110 contacts the Component Client 120, 445 and assigns it the task of stopping the Software Component 200 by passing the Component Details 450.

On being notified by the Component Server 110 the Component Client 120 starts the shutdown process 455 and reads the Component Details given to it 460. If the Software Component 200 has been started by SCC, the Component Client 120 extracts the Process ID of the Software Component 200 from Component Reference Repository 150 465. The Component Client 120 then shuts down the Software Component 200 by invoking the Operating System to kill the Process ID of the Component 470. The Component Client 120 then deletes the Process ID from the Component Reference Repository 150, 475.

In an example, where there is no Process ID in the Component Reference Repository 150, 480, the Component Client 120 retrieves the Component Reference from the Component Reference Repository 150 482. The Component Client 120 executes the Invoking Code 484 of the Software Component 200 and triggers the Component Shutdown Code in the Software Component 200, 486. The Software Component 200 executes the Component Shutdown Code thereby shutting down itself 488.

The Component Client 120 notifies the Component Server 110 on successful completion of the task 490. The Component Server 110 then updates the Component Server Registry 130, 492. Finally, the Component Server 110 notifies the Application 100 or the user of the successful completion of the task 494.

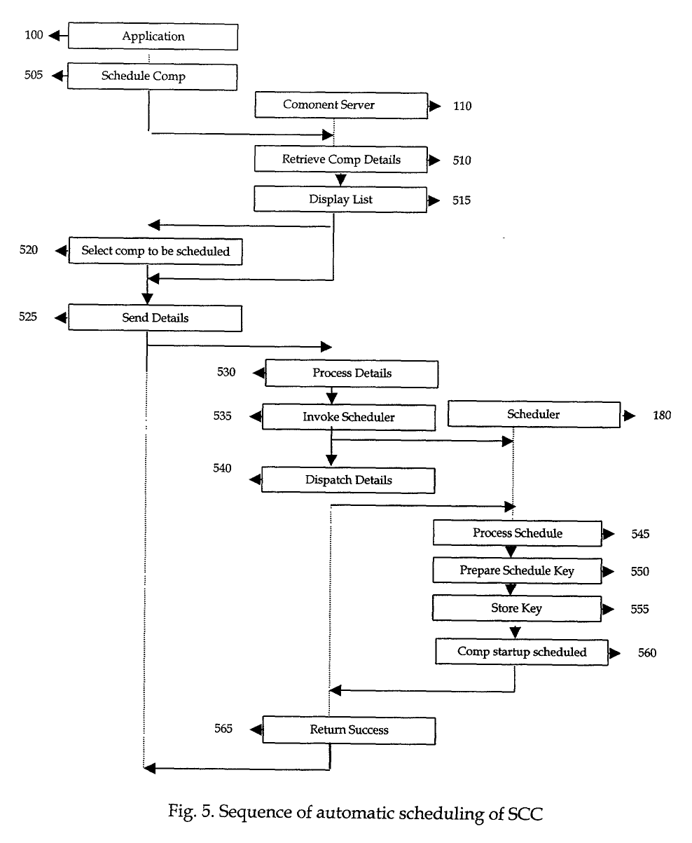

FIG. 5 illustrates an example of how the SCC may schedule the startup or shutdown of Components 200, 205. The user selects the menu from the user interface of the Application 100 to schedule the startup and shutdown of Components 200, 205 and the Application 100 informs the Component Server 110 of the users choice 505. The Component Server 110 retrieves the Component Details from the Component Server Registry 130, 510, and displays it in the user interface of the Application 100, 515. The user selects the Software Component 200, 205 to be scheduled 520, selects the schedule parameters and the Application 100 informs the Component Server 110 regarding the user's choice 525. The Component Server 110 reads the scheduling details 530. It invokes the Scheduler 180 to schedule the task 535 and hands over the scheduling details of the Software Component 200, 205 to the Scheduler 180, 540.

The Scheduler 180 processes the scheduling details 545 and prepares the Schedule Key 550. The Schedule Key contains the name of the Component Client 120, the details of the Software Component 200, the action to be performed and the time at which this action is to be performed, and any other parameters selected by the User. The Scheduler 180 and stores the Schedule Key in the Component Server Registry 130, 555 and returns a message of successful storing of the Schedule Key to the Component Server 110, 560.

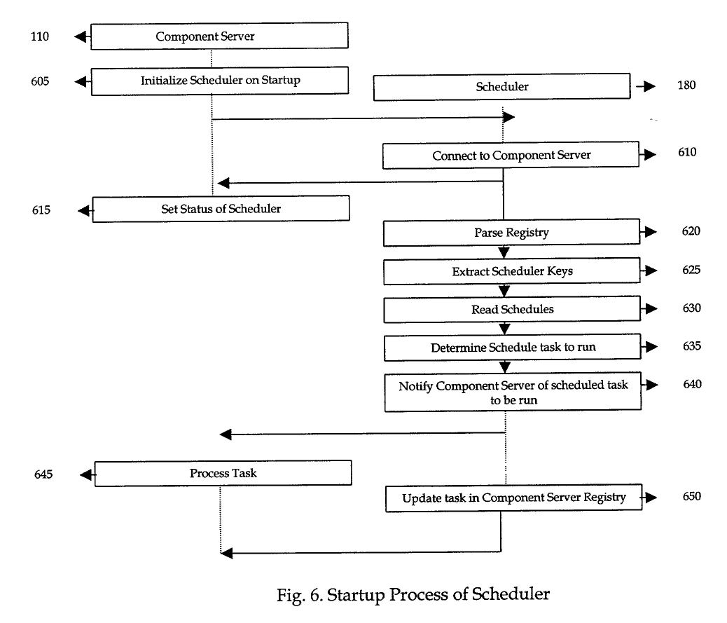

FIG. 6 illustrates an example of the Startup Process of the Scheduler. On startup, the Component Server 110 runs the Scheduler 180, 605, and thereby establishes a connection between the Component Server 110 and the Scheduler 180, 610. The Component Server 110 then updates the status of the Scheduler 180 in the Component Server Registry 130, 615. The Scheduler 180 parses the Component Server Registry 130, 620, extracts the Schedule Key 625, reads the schedule 630, identifies the schedule to be run 635, and notifies the Component Server 110 of the scheduled task to be run 640. The Component Server 110 then processes the scheduled task 645. The Scheduler 180 updates the Component Server Registry 130, with the task performed by it 650.

What is claimed is:

1. A system for controlling software components, comprising:
a) a first computing environment, the first computing environment configured to include:
1) a component server
2) a client reference repository associated with the component server including a predetermined client reference corresponding to a component client; and
3) a registry associated with the component server, the registry including predetermined component details corresponding to the software component and predetermined client details corresponding to the Component Client; and
b) a second computing environment, the second computing environment configured to include:
1) a component client, responsive to the component server;
2) a component reference repository associated with the component client; and
3) at least one software component, responsive to the component client;
wherein the software component of the second computing environment is responsive to the component server of the first computing environment by way of the component client of the second computing environment.

2. The system of claim 1, wherein the first and second computing environments are physically located on a single computer.

3. The system of claim 1, wherein the first computing environment comprises a first computer, the second computing environment comprises a second computer, and wherein the first and second computers are in electronic communication.

4. The system of claim 1, wherein the first computing environment includes a first operating system and the second computing environment includes a second operating system, wherein the first operating system is different from the second operating system.

5. The system of claim 1, wherein the first computing environment includes a first operating system and the second computing environment includes a second operating system, wherein the first operating system is the same as the second operating system.

6. The system of claim 1, wherein the component details comprise the bind name and location of the software component.

7. The system of claim 1, wherein the component reference repository includes a component reference relating to the software component.

8. The system of claim 1, wherein the component reference repository includes a process ID relating to the software component.

9. The system of claim 1, wherein the component reference repository includes an invoking object relating to the software component.

10. The system of claim 1, wherein a shutdown object is integrated into the software component.

11. The system of claim 1, wherein the first computing environment further includes an application including shutdown code provided by the component server.

12. The system of claim 1, wherein the software component is responsive to start and shutdown commands from the component server by way of the component client.

13. The system of claim 1, further comprising a third computing environment, the third computing environment configured to include a scheduler, and wherein the component server is responsive to the scheduler.

14. The system of claim 1, wherein the software component comprises a plurality of software components responsive to the component client comprises a plurality of component clients.

15. The system of claim 1, wherein the component client comprises a plurality of component clients.

16. The system of claim 1, wherein the component client comprises a first component client, and the system further comprising a fourth computing environment, the forth computing environment configured to include a second component client.

17. A method for controlling software components, comprising:
a) configuring a first computing environment to include:
1) a component server
2) a client reference repository associated with the component server including a predetermined client reference corresponding to a component client; and
3) a registry associated with the component server, the registry including predetermined component details corresponding to the software component and predetermined client details corresponding to the software component;
b) configuring a second computing environment to include:
1) a component client, responsive to the component server;
2) a component reference repository associated with the component client; and
3) at least one software component, responsive to the component client; and
c) controlling the software component of the second computing environment with the component server of the first computing environment by way of the component client of the second computing environment.

18. The method of claim 17, wherein the component details comprise the bind name and location of the software component.

19. The method of claim 17, wherein the component server:
1) reads and stores information of the software component;
2) generates shutdown codes for the software component;
3) parses through the registry to determine the component client in the same computing environment as the software component; and
4) configures the component client in the same computing environment as the software component to control the software component.

20. The method of claim 19, wherein the component server generates a startup code to enable automated start up of the software components.

21. The method of claim 19, wherein the component server:
1) receives component details relating to the software component from an application;
2) stores the component details in a first temporary storage object;
3) stores a remote reference of the software component in a second temporary storage object; and
4) retains the temporary storage objects on the component server until the software component is configured with the component client.

22. The method of claim 21, wherein the component server:
1) transfers the first and second temporary storage objects to the component client;
2) updates the client reference repository;
3) updates the registry with the component details of the software component.

23. The method of claim 19, wherein the component server:
1) generates a component shutdown code which is stored in a shutdown object;
2) generates an invoking code which is stored in a invoking object;
3) transfers the shutdown object to an application; and
4) transfers the invoking object to the component client.

24. The method of claim 23, wherein the component server generates a single shutdown code for a plurality of software components.

25. The method of claim 23, wherein the component server generates a distinct invoking code for each of a plurality of software components.

26. The method of claim 23, wherein the component server:
1) generates a startup code containing the startup parameters specific to the component which is stored in a startup object;
2) generates the startup code to invoke the operating system to start the software component;
3) generates the startup code to obtain the process ID of the software component at startup; and
4) transfers the startup code to the component client.

27. The method of claim 17, wherein the client component stores a reference and a process ID of the software component in the component reference repository.

28. The method of claim 17, wherein the software component responds to start and shutdown commands from the component server by way of the component client.

29. The method of claim 28, wherein the component server:
1) receives the information corresponding to the software component;
2) parses through the registry to identify the component client as being associated with the computing environment of the software component; and
3) assigns startup and shutdown tasks to the component client.

30. The method of claim 29, wherein the component server contacts the component client and transfers the component details to the component client.

31. The method of claim 28, wherein the component client:
1) reads the location of the software component from the component details of the software component received from the component server;
2) starts the software component by invoking a local Java Virtual Machine;
3) obtains the process ID of the software component from an operating system; and
4) stores the process ID in the component reference repository.

32. The method of claim 28, wherein the component client starts the software component by loading libraries associated with the software component.

33. The method of claim 28, wherein the component client starts the software component by executing at least one executable file associated with the software component.

34. The system of claim 28, wherein the component client:
1) reads the location of the software component from the component details received from the component server; and
2) shuts down the software component by extracting and killing the process ID.

35. The method of claim 34, wherein the process ID is mapped with the component details which enables the component client to identify and extract the process ID at the time of shutdown.

36. The method of claim 34, wherein the component client reads the process ID and deletes the process ID from the component reference repository.

37. The method of claim 28, wherein the component server shuts down the software component by invoking a shutdown code in the software component.

38. The method of claim 28, wherein the component client shuts down the software component by invoking a shutdown code, wherein the component client:
1) retrieves a remote reference of the software component from the component reference repository;
2) executes an invoking code corresponding to the software component;
3) triggers a shutdown code with the invoking code; and
4) executes the shutdown code of the software component.

39. The method of claim 28, further comprising a configuring third computing environment, to include a scheduler, wherein the component server is responsive to the scheduler.

40. The method of claim 39, wherein the component server further:
1) receives the component details of the software component from an application;
2) invokes a scheduler with the component details:
3) establishes a connection with the scheduler; and
4) processes startup and shutdown of the software component upon notification from the scheduler.

41. The method of claim 40, wherein the component server further:
1) runs the scheduler at startup; and
2) updates the registry with the status of the scheduler.

42. The method of claim 41, wherein the wherein the scheduler further:
1) prepares a schedule key and store the schedule key with the registry;
2) parses the registry and extracts the schedule key on establishing connection with the server; and
3) determines the scheduled task to be run and notifies the component server regarding the same.

43. The method of claim 42, wherein the scheduler prepares a schedule key by:
1) processing the component details of the software components;
2) preparing the schedule of startup and shutdown of the components; and
3) storing the schedule in the schedule key.
